(19) United States
(12) Patent Application Publication
(10) Pub. No.: US 2026/0009690 A1
(43) Pub. Date: Jan. 8, 2026

(54) ABNORMALITY DETERMINATION DEVICE AND ABNORMALITY DETERMINATION METHOD

(71) Applicant: HONDA MOTOR CO., LTD., MINATO-KU (JP)

(72) Inventors: Satoru KAWASE, WAKO-SHI (JP); Kazuyuki KADOWAKI, WAKO-SHI (JP); Tsubasa NISHIOKA, WAKO-SHI (JP)

(21) Appl. No.: 19/256,522

(22) Filed: Jul. 1, 2025

(30) Foreign Application Priority Data
Jul. 5, 2024 (JP) 2024-108983

(51) Int. Cl. G01L 27/00; G01N 9/26; H01M 8/04664

(52) U.S. Cl. CPC G01L 27/007; G01N 9/266; H01M 8/04686

(57) ABSTRACT

An abnormality determination device includes: a first gas density acquisition unit that acquires a first gas density, which is a density of a gas in a gas reservoir unit when the gas reservoir unit has been filled with the gas via a gas filling path; a second gas density acquisition unit that acquires a second gas density, which is a density of the gas in the gas reservoir unit when the gas is supplied from the gas reservoir unit via a gas supply path; and an abnormality determination unit that determines whether or not a first pressure sensor or a second pressure sensor is abnormal, based on the first gas density acquired by the first gas density acquisition unit and the second gas density acquired by the second gas density acquisition unit.

### CROSS-REFERENCE TO RELATED APPLICATIONS

This application is based upon and claims the benefit of priority from Japanese Patent Application No. 2024-108983 filed on Jul. 5, 2024, the contents of which are incorporated herein by reference.

### BACKGROUND OF THE INVENTION

### Field of the Invention

The present disclosure relates to an abnormality determination device and an abnormality determination method.

### Description of the Related Art

JP 2010-003518 A discloses a technique for determining an abnormality of a pressure sensor provided in a fuel cell system.

### SUMMARY OF THE INVENTION

There is a demand for a technique that can suitably determine an abnormality of a pressure sensor.

The present disclosure has the object of solving the above-described problem.

A first aspect of the present disclosure is an abnormality determination device comprising: a first gas density acquisition unit configured to acquire a first gas density, which is a density of a gas in a gas reservoir unit when the gas reservoir unit has been filled with the gas via a gas filling path, based on a pressure of the gas detected by a first pressure sensor provided in the gas filling path and a temperature of the gas detected by a temperature sensor provided in the gas reservoir unit; a second gas density acquisition unit configured to acquire a second gas density, which is a density of the gas in the gas reservoir unit when the gas is supplied from the gas reservoir unit via a gas supply path, based on a pressure of the gas detected by a second pressure sensor provided in the gas supply path and a temperature of the gas detected by the temperature sensor; and an abnormality determination unit configured to determine whether or not the first pressure sensor or the second pressure sensor is abnormal, based on the first gas density acquired by the first gas density acquisition unit and the second gas density acquired by the second gas density acquisition unit.

A second aspect of the present disclosure is an abnormality determination method comprising: acquiring a first gas density, which is a density of a gas in a gas reservoir unit when the gas reservoir unit has been filled with the gas via a gas filling path, based on a pressure of the gas detected by a first pressure sensor provided in the gas filling path and a temperature of the gas detected by a temperature sensor provided in the gas reservoir unit; acquiring a second gas density, which is a density of the gas in the gas reservoir unit when the gas is supplied from the gas reservoir unit via a gas supply path, based on a pressure of the gas detected by a second pressure sensor provided in the gas supply path and a temperature of the gas detected by the temperature sensor; and determining whether or not the first pressure sensor or the second pressure sensor is abnormal, based on the first gas density that has been acquired and the second gas density that has been acquired.

According to the present disclosure, it is possible to suitably determine an abnormality of a pressure sensor.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a fuel cell system including an abnormality determination device;

FIG. 2 is a schematic diagram of a map;

FIG. 3 is a flowchart of processes performed by the abnormality determination device;

FIG. 4 is a schematic diagram of determination of an abnormality of a pressure sensor; and

FIG. 5 is a block diagram of the fuel cell system.

### DETAILED DESCRIPTION OF THE INVENTION

An abnormality determination device according to the present disclosure can be used in a system that fills a gas reservoir unit with a gas via a filling port and supplies the gas from the gas reservoir unit to a gas supply target.

Hereinafter, an abnormality determination device provided in a fuel cell system that supplies a fuel gas (hydrogen gas) from a gas reservoir unit to a fuel cell will be described. The fuel cell system is provided in, for example, a fuel cell vehicle.

### 1. Configuration of Fuel Cell System 10

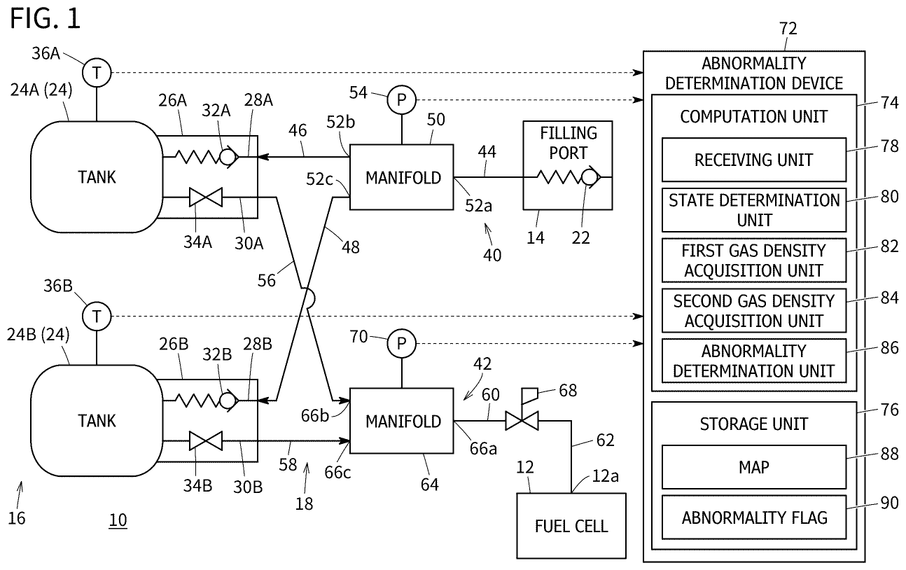

FIG. 1 is a schematic configuration diagram of a fuel cell system 10 including an abnormality determination device 72. The fuel cell system 10 includes a fuel cell 12, a filling port 14, a gas reservoir unit 16, and a gas flow path 18.

The fuel cell 12 outputs electric power generated by a chemical reaction between a fuel gas and an oxygen-containing gas. The fuel cell 12 uses hydrogen gas stored in the gas reservoir unit 16 as the fuel gas. Further, the fuel cell 12 uses the outside air as the oxygen-containing gas.

The filling port 14 is, for example, a receptacle structure. A filling nozzle provided in a hydrogen station or the like is attachable to and detachable from the filling port 14. The filling port 14 is provided with a check valve 22. The check valve 22 is disposed so as to allow the hydrogen gas to flow into the gas reservoir unit 16 from the outside and to prevent the hydrogen gas from flowing out from the gas reservoir unit 16 to the outside.

The gas reservoir unit 16 includes two tanks 24 (a tank 24A and a tank 24B). It should be noted that the gas reservoir unit 16 may include one tank 24 or three or more tanks 24.

The tank 24A includes a liner (not shown), a reinforcing layer (not shown), and a cap 26A. The liner is formed of, for example, a resin. Hydrogen gas is stored inside the liner. The reinforcing layer is formed of, for example, CFRP. The reinforcing layer covers the outer peripheral surface of the liner. The cap 26A is formed of, for example, a metal (aluminum). The cap 26A includes an introduction path 28A for the hydrogen gas and a discharge path 30A for the hydrogen gas. A check valve 32A is disposed in the introduction path 28A. The check valve 32A is disposed so as to allow the hydrogen gas to flow from the outside of the tank 24A to the inside thereof and to prevent the hydrogen gas from flowing out from the inside of the tank 24A to the outside thereof. A main stop valve 34A is disposed in the discharge path 30A. The main stop valve 34A opens and closes in response to an electric signal supplied from the outside.

The tank 24A is provided with a temperature sensor 36A. The temperature sensor 36A detects the temperature of the hydrogen gas stored in the tank 24A. The temperature sensor 36A outputs a signal indicating the detected temperature to an abnormality determination device 72 described later.

The tank 24B includes a liner (not shown), a reinforcing layer (not shown), and a cap 26B. The liner is formed of, for example, a resin. Hydrogen gas is stored inside the liner. The reinforcing layer is formed of, for example, CFRP. The reinforcing layer covers the outer peripheral surface of the liner. The cap 26B is formed of, for example, a metal (aluminum). The cap 26B includes an introduction path 28B for the hydrogen gas and a discharge path 30B for the hydrogen gas. A check valve 32B is disposed in the introduction path 28B. The check valve 32B is disposed so as to allow the hydrogen gas to flow from the outside of the tank 24B to the inside thereof and to prevent the hydrogen gas from flowing out from the inside of the tank 24B to the outside thereof. A main stop valve 34B is disposed in the discharge path 30B. The main stop valve 34B opens and closes in response to an electric signal supplied from the outside.

The tank 24B is provided with a temperature sensor 36B. The temperature sensor 36B detects the temperature of the hydrogen gas stored in the tank 24B. The temperature sensor 36B outputs a signal indicating the detected temperature to the abnormality determination device 72 described later.

The gas flow path 18 includes a gas filling path 40 and a gas supply path 42 through which the gas can flow. The gas filling path 40 connects the filling port 14 and each of the tanks 24. The gas supply path 42 connects each of the tanks 24 and the fuel cell 12.

The gas filling path 40 includes a partial filling path 44, a partial filling path 46, a partial filling path 48, and a manifold 50. The partial filling path 44 connects the check valve 22 of the filling port 14 and an opening 52a of the manifold 50. The partial filling path 46 connects an opening 52b of the manifold 50 and the introduction path 28A of the tank 24A. The partial filling path 48 connects an opening 52c of the manifold 50 and the introduction path 28B of the tank 24B. The manifold 50 includes the opening 52a, the opening 52b, and the opening 52c. The opening 52a and the opening 52b communicate with each other via a flow path formed in the manifold 50. The opening 52a and the opening 52c communicate with each other via a flow path formed in the manifold 50.

The manifold 50 is provided with a first pressure sensor 54. The first pressure sensor 54 detects the pressure of the hydrogen gas in a flow path (a part of the gas filling path 40) formed in the manifold 50. The pressure detected by the first pressure sensor 54 corresponds to the pressure of the hydrogen gas in the tank 24 (the pressure in the gas reservoir unit 16) when filled with the gas. The first pressure sensor 54 outputs a signal indicating the detected pressure to the abnormality determination device 72 described later.

The gas supply path 42 includes a partial supply path 56, a partial supply path 58, a partial supply path 60, a partial supply path 62, a regulator 68, and a manifold 64. The partial supply path 56 connects the discharge path 30A of the tank 24A and an opening 66b of the manifold 64. The partial supply path 58 connects the discharge path 30B of the tank 24B and an opening 66c of the manifold 64. The partial supply path 60 connects an opening 66a of the manifold 64 and one end of the regulator 68. The partial supply path 62 connects the other end of the regulator 68 and a gas inlet 12a of the fuel cell 12. The manifold 64 includes the opening 66a, the opening 66b, and the opening 66c. The opening 66a and the opening 66b communicate with each other via a flow path formed in the manifold 64. The opening 66a and the opening 66c communicate with each other via a flow path formed in the manifold 64.

The manifold 64 is provided with a second pressure sensor 70. The second pressure sensor 70 detects the pressure of the hydrogen gas in a flow path (a part of the gas supply path 42) formed in the manifold 64. The pressure detected by the second pressure sensor 70 corresponds to the pressure of the hydrogen gas in the tank 24 (the pressure in the gas reservoir unit 16) during gas supply. The second pressure sensor 70 outputs a signal indicating the detected pressure to the abnormality determination device 72 described later.

The fuel cell system 10 includes the abnormality determination device 72. The abnormality determination device 72 includes a computation unit 74 and a storage unit 76.

The computation unit 74 may be constituted by a processor such as a central processing unit (CPU) or a graphics processing unit (GPU). That is, the computation unit 74 may be constituted by processing circuitry. At least part of the computation unit 74 may be realized by an integrated circuit such as an application specific integrated circuit (ASIC) or a field-programmable gate array (FPGA). At least part of the computation unit 74 may be realized by an electronic circuit including a discrete device.

The computation unit 74 includes a receiving unit 78, a state determination unit 80, a first gas density acquisition unit 82, a second gas density acquisition unit 84, and an abnormality determination unit 86. The receiving unit 78, the state determination unit 80, the first gas density acquisition unit 82, the second gas density acquisition unit 84, and the abnormality determination unit 86 can be realized by the computation unit 74 executing a program stored in the storage unit 76.

The receiving unit 78 acquires various signals transmitted from the outside of the abnormality determination device 72 to the abnormality determination device 72. The state determination unit 80 determines whether or not the gas reservoir unit 16 has been filled with hydrogen gas. Further, the state determination unit 80 determines whether or not the hydrogen gas is supplied from the gas reservoir unit 16 to the fuel cell 12. The first gas density acquisition unit 82 acquires the density of the hydrogen gas in the gas reservoir unit 16 when the gas reservoir unit 16 has been filled with the hydrogen gas via the gas filling path 40. At this time, the highest density value among the acquired densities of the hydrogen gas may be acquired and stored. The density of the hydrogen gas acquired by the first gas density acquisition unit 82 is referred to as a first gas density. The second gas density acquisition unit 84 acquires the density of the hydrogen gas in the gas reservoir unit 16 when the hydrogen gas is supplied from the gas reservoir unit 16 via the gas supply path 42. At this time, the highest density value among the acquired densities of the hydrogen gas may be acquired and stored. The density of the hydrogen gas acquired by the second gas density acquisition unit 84 is referred to as a second gas density. The abnormality determination unit 86 determines whether or not the first pressure sensor 54 or the second pressure sensor 70 is abnormal, based on the first gas density and the second gas density.

The storage unit 76 is a computer-readable storage medium. The storage unit 76 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 76 may be included in the processor, the integrated circuit, or the like described above.

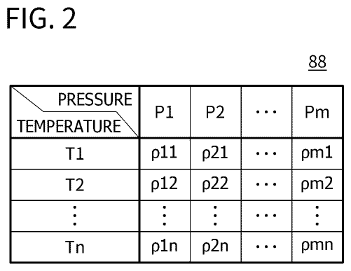

The storage unit 76 stores a map 88. FIG. 2 is a schematic diagram of the map 88. The map 88 associates pressures (P1 to Pm) of the hydrogen gas, temperatures (T1 to Tn) of the hydrogen gas, and densities (ρ 11 to ρ mn) of the hydrogen gas with each other. It should be noted that a compressibility factor is taken into consideration in each density of the hydrogen gas in the map 88.

Further, the storage unit 76 stores an abnormality flag 90. The abnormality flag 90 is information indicating whether or not at least one of the first pressure sensor 54 or the second pressure sensor 70 is abnormal. In the case where the first pressure sensor 54 and the second pressure sensor 70 are not abnormal, the abnormality flag 90 is set to “0”. In the case where at least one of the first pressure sensor 54 or the second pressure sensor 70 is abnormal, the abnormality flag 90 is set to “1”. The initial value of the abnormality flag 90 is “0”.

### 2. Flow of Hydrogen Gas in Fuel Cell System 10

The flow of hydrogen gas in the fuel cell system 10 will be described with reference to FIG. 1. When the gas reservoir unit 16 is filled with hydrogen gas, the filling nozzle provided in the hydrogen station is connected to the filling port 14. The hydrogen gas supplied from the filling nozzle flows into the manifold 50 via the partial filling path 44. The hydrogen gas flowing into the manifold 50 is divided into two parts. One part of the hydrogen gas flows into the tank 24A via the partial filling path 46. The other part of the hydrogen gas flows into the tank 24B via the partial filling path 48. The first pressure sensor 54 detects the pressure of the hydrogen gas in the manifold 50. At this time, the main stop valve 34A and the main stop valve 34B are closed.

When the hydrogen gas is supplied from the gas reservoir unit 16 to the fuel cell 12, the main stop valve 34A and the main stop valve 34B are opened. As a result, the hydrogen gas stored in the tank 24A flows into the manifold 64 via the partial supply path 56. The hydrogen gas stored in the tank 24B flows into the manifold 64 via the partial supply path 58. The hydrogen gas flowing into the manifold 64 from the two paths merges. The merged hydrogen gas flows into the fuel cell 12 via the partial supply path 60, the regulator 68, and the partial supply path 62. The second pressure sensor 70 detects the pressure of the hydrogen gas in the manifold 64.

### 3. Operation of Abnormality Determination Device 72

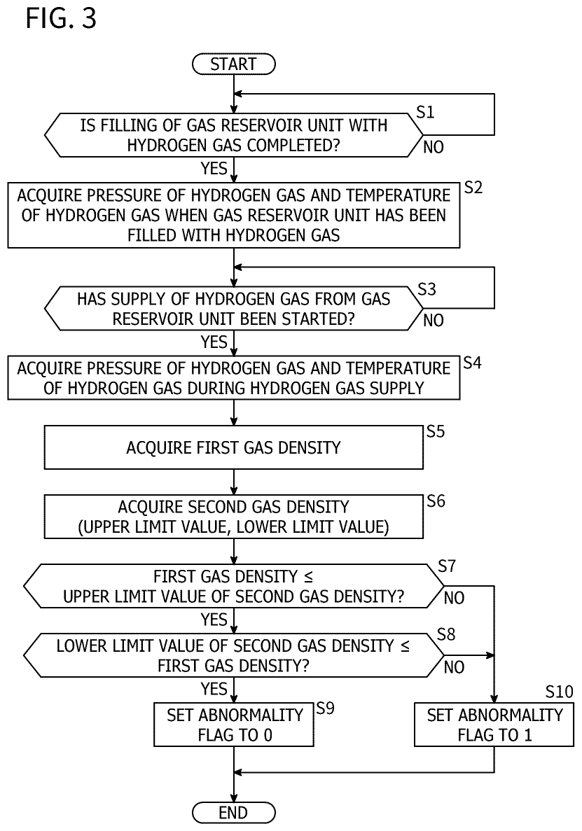

FIG. 3 is a flowchart of processes performed by the abnormality determination device 72. The abnormality determination device 72 starts a series of processes shown in FIG. 3 in the case where filling of the gas reservoir unit 16 with hydrogen gas is started. For example, in the case where the filling nozzle provided in the hydrogen station is connected to the filling port 14, a first signal is output from a non-illustrated sensor (for example, a proximity sensor) provided at the filling port 14 to the abnormality determination device 72. When the receiving unit 78 acquires the first signal, the abnormality determination device 72 starts the series of processes shown in FIG. 3.

In step S1, the state determination unit 80 determines whether or not filling of the gas reservoir unit 16 with hydrogen gas is completed. For example, it may be determined that filling is completed based on the fact that the pressure value detected by the first pressure sensor 54 on the filling side rises to a predetermined value or more, or has exceeded the predetermined value. When the filling of the gas reservoir unit 16 with the hydrogen gas is completed, the filling nozzle is removed from the filling port 14. At this time, a second signal is output from the non-illustrated sensor (for example, a proximity sensor) provided at the filling port 14 to the abnormality determination device 72. When the receiving unit 78 acquires the second signal, the state determination unit 80 determines that the filling of the gas reservoir unit 16 with the hydrogen gas is completed. In the case where the filling of the gas reservoir unit 16 with the hydrogen gas is completed (step S1: YES), the process proceeds to step S2. On the other hand, in the case where the filling of the gas reservoir unit 16 with the hydrogen gas is not completed (step S1: NO), the determination of step S1 is continuously performed.

When the process proceeds from step S1 to step S2, the receiving unit 78 acquires signals output from the first pressure sensor 54, the temperature sensor 36A, and the temperature sensor 36B. The signals of the first pressure sensor 54 acquired at this time indicate the pressure of the hydrogen gas in the tank 24A and the pressure of the hydrogen gas in the tank 24B when the gas reservoir unit 16 has been filled with the hydrogen gas. Further, the signal of the temperature sensor 36A acquired at this time indicates the temperature of the hydrogen gas in the tank 24A when the gas reservoir unit 16 has been filled with the hydrogen gas. The signal of the temperature sensor 36B acquired at this time indicates the temperature of the hydrogen gas in the tank 24B when the gas reservoir unit 16 has been filled with the hydrogen gas. The information thus acquired is stored in the storage unit 76. When step S2 ends, the process proceeds to step S3.

In step S3, the state determination unit 80 determines whether or not the supply of hydrogen gas from the gas reservoir unit 16 has been started. That is, the state determination unit 80 determines whether or not the hydrogen gas has been supplied from the gas reservoir unit 16 to the fuel cell 12 for the first time after filling of the hydrogen gas. For example, when an ignition switch (also referred to as a start switch) of the fuel cell vehicle is operated from off to on, the main stop valve 34A and the main stop valve 34B are opened. As a result, the supply of the hydrogen gas from the gas reservoir unit 16 to the fuel cell 12 is started. When the receiving unit 78 acquires the operation signal of the ignition switch, the state determination unit 80 determines that the supply of the hydrogen gas from the gas reservoir unit 16 has been started. In the case where the supply of the hydrogen gas from the gas reservoir unit 16 has been started (step S3: YES), the process proceeds to step S4. On the other hand, in the case where the supply of the hydrogen gas from the gas reservoir unit 16 has not been started (step S3: NO), the determination of step S3 is continuously performed.

When the process proceeds from step S3 to step S4, the receiving unit 78 acquires signals output from the second pressure sensor 70, the temperature sensor 36A, and the temperature sensor 36B. The signal of the second pressure sensor 70 acquired at this time indicates the pressure of the hydrogen gas in the tank 24B when the hydrogen gas is supplied. Further, the signal of the temperature sensor 36A acquired at this time indicates the temperature of the hydrogen gas in the tank 24A when the hydrogen gas is supplied. The signal of the temperature sensor 36B acquired at this time indicates the temperature of the hydrogen gas in the tank 24B when the hydrogen gas is supplied. The information thus acquired is stored in the storage unit 76. When step S4 ends, the process proceeds to step S5.

In step S5, the first gas density acquisition unit 82 acquires the first gas density. As described above, the first gas density is the density of the hydrogen gas in the gas reservoir unit 16 when the gas reservoir unit 16 has been filled with the hydrogen gas via the gas filling path 40. It should be noted that, in the case where the gas reservoir unit 16 includes a plurality of tanks 24 as in the present embodiment, the densities of the hydrogen gas in the respective tanks 24 after filling of the gas may differ depending on the temperature influence on each tank 24 during filling of the gas and the filling state (residual gas capacity) of each tank 24 before filling of the gas. Therefore, in the case where the gas reservoir unit 16 includes a plurality of tanks 24, the first gas density acquisition unit 82 calculates the average density of the hydrogen gas in the gas reservoir unit 16, and sets the calculated average density as the first gas density. Specifically, the first gas density acquisition unit 82 performs the following process.

The first gas density acquisition unit 82 acquires the density of the hydrogen gas in the tank 24A based on the pressure acquired in step S2, the temperature in the tank 24A acquired in step S2, and the map 88. Similarly, the first gas density acquisition unit 82 acquires the density of the hydrogen gas in the tank 24B based on the pressure acquired in step S2, the temperature in the tank 24B acquired in step S2, and the map 88. After acquiring the densities of the hydrogen gas in the respective tanks 24, the first gas density acquisition unit 82 calculates an average density (the first gas density) of the density of the hydrogen gas in the tank 24A and the density of the hydrogen gas in the tank 24B using the following Expression (1).

$$p = \frac{ρ A \cdot V A + ρ B \cdot VB}{V A + V B} \qquad ( 1 )$$

ρ: Average density of hydrogen gas
ρA: Density of hydrogen gas in tank 24A
ρB: Density of hydrogen gas in tank 24B
VA: Capacity of tank 24A
VB: Capacity of tank 24B
(VA and VB are stored in the storage unit 76 in advance.)

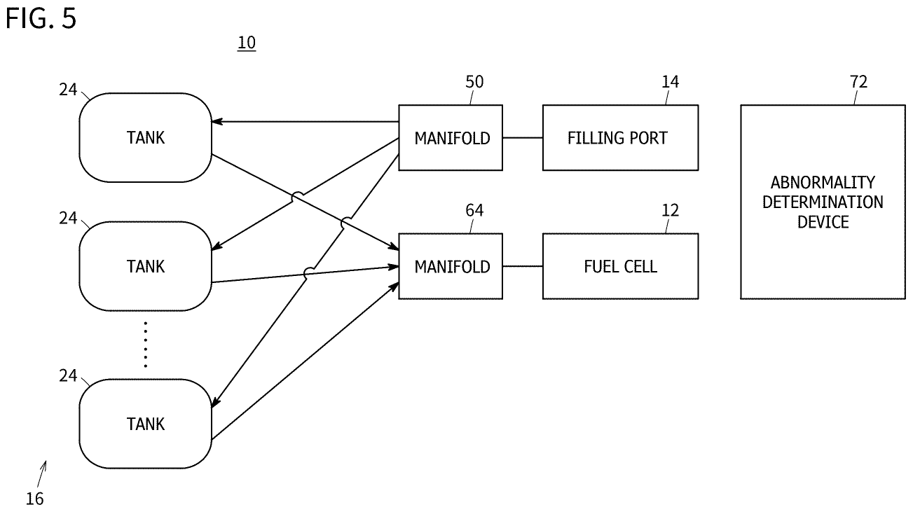

It should be noted that, as shown in FIG. 5, the fuel cell system 10 may include three or more tanks 24. FIG. 5 is a block diagram of the fuel cell system 10. FIG. 5 shows a part of the configuration of FIG. 1 (the fuel cell 12, the filling port 14, the tanks 24, the manifold 50, the manifold 64, and the abnormality determination device 72) in a block form. FIG. 5 shows three or more tanks 24. The lines between the blocks indicate the flow paths of the gas. The arrows attached to the flow paths indicate the directions of flow of the hydrogen gas. In this case, each tank 24 is connected to the manifold 50 on the filling side and the manifold 64 on the supply side via the gas flow paths. When the number of the tanks 24 is three or more (N), the first gas density acquisition unit 82 may calculate the average density using the following Expression (1)′.

$$ρ = \frac{ρ A \cdot V A + ρ B \cdot VB + … ρ N \cdot VN}{V A + V B + … VN} \qquad {( 1 )}^{′}$$

In this manner, a capacity ratio, which is the ratio of the capacity of the tank 24 to the total capacity of the plurality of tanks 24, is calculated for each tank 24. Further, the average density of the gas is calculated based on the density of the gas in each tank 24 and the capacity ratio of each tank 24.

It should be noted that, in the case where the gas reservoir unit 16 includes one tank 24, the calculation using the above Expression (1) is not necessary. In the case where the gas reservoir unit 16 includes one tank 24, the first gas density acquisition unit 82 acquires the density based on the pressure acquired in step S2, the temperature in the tank 24 acquired in step S2, and the map 88. The first gas density acquisition unit 82 sets this density as the first gas density. The first gas density thus obtained is stored in the storage unit 76. When step S5 ends, the process proceeds to step S6.

In step S6, the second gas density acquisition unit 84 acquires the second gas density. As described above, the second gas density is the density of the hydrogen gas in the gas reservoir unit 16 when the hydrogen gas is supplied from the gas reservoir unit 16 via the gas supply path 42. In the case where the gas reservoir unit 16 includes a plurality of tanks 24, the second gas density acquisition unit 84 calculates the average density of the hydrogen gas in the gas reservoir unit 16, and sets the calculated average density as the second gas density. Further, the second gas density acquisition unit 84 acquires a range of the second gas density in which an error of the pressure sensor is taken into consideration. For example, the second gas density acquisition unit 84 acquires an upper limit value of the second gas density obtained in consideration of the error of the pressure sensor and a lower limit value of the second gas density obtained in consideration of the error of the pressure sensor. Specifically, the second gas density acquisition unit 84 performs the following process.

First, the second gas density acquisition unit 84 calculates an upper limit value and a lower limit value of an error range for the pressure acquired in step S4. For example, an upper limit value of the second pressure sensor 70 is calculated by [acquired pressure×(100%+error rate of pressure sensor)]. A lower limit value of the second pressure sensor 70 is calculated by [acquired pressure×(100%−error rate of pressure sensor)]. Alternatively, the upper limit value of the second pressure sensor 70 may be calculated by [acquired pressure+predetermined value]. The lower limit value of the second pressure sensor 70 may be calculated by [acquired pressure−predetermined value].

Next, the second gas density acquisition unit 84 acquires an upper limit value of the density of the hydrogen gas in the tank 24A based on the upper limit value of the second pressure sensor 70, the temperature in the tank 24A acquired in step S4, and the map 88. Similarly, the second gas density acquisition unit 84 acquires an upper limit value of the density of the hydrogen gas in the tank 24B based on the upper limit value of the second pressure sensor 70, the temperature in the tank 24B acquired in step S4, and the map 88.

Further, the second gas density acquisition unit 84 calculates an average density of the upper limit value of the density of the hydrogen gas in the tank 24A and the upper limit value of the density of the hydrogen gas in the tank 24B using the above Expression (1). In this case, in the Expression (1), the upper limit value of the density of the hydrogen gas in the tank 24A is set to the parameter ρA, and the upper limit value of the density of the hydrogen gas in the tank 24B is set to the parameter ρB. ρ calculated by the above Expression (1) is an upper limit value of the second gas density. The upper limit value of the second gas density obtained in this manner is stored in the storage unit 76.

The second gas density acquisition unit 84 calculates a lower limit value of the second gas density in the same manner as the upper limit value of the second gas density. The lower limit value of the second gas density obtained in this manner is stored in the storage unit 76. Through the above process, the second gas density acquisition unit 84 acquires the upper limit value of the second gas density and the lower limit value of the second gas density. When step S6 ends, the process proceeds to step S7.

In step S7, the abnormality determination unit 86 compares the first gas density acquired in step S5 with the upper limit value of the second gas density acquired in step S6. In the case where the first gas density is equal to or lower than the upper limit value of the second gas density (step S7: YES), the process proceeds to step S8. On the other hand, in the case where the first gas density is higher than the upper limit value of the second gas density (step S7: NO), the process proceeds to step S10.

When the process proceeds from step S7 to step S8, the abnormality determination unit 86 compares the first gas density acquired in step S5 with the lower limit value of the second gas density acquired in step S6. In the case where the first gas density is equal to or higher than the lower limit value of the second gas density (step S8: YES), the process proceeds to step S9. On the other hand, in the case where the first gas density is lower than the lower limit value of the second gas density (step S8: NO), the process proceeds to step S10.

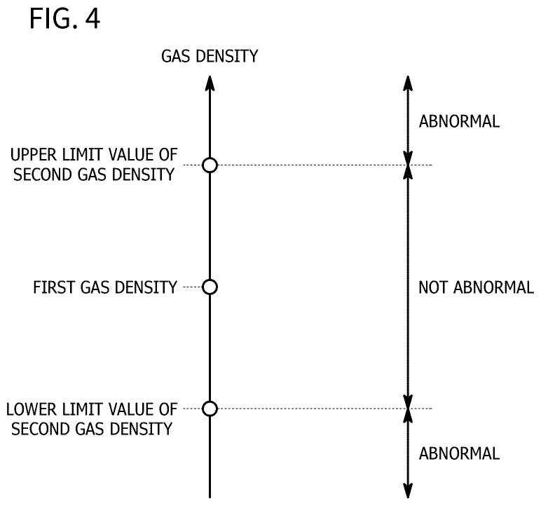

When the process proceeds from step S8 to step S9, the abnormality determination unit 86 determines that the first pressure sensor 54 and the second pressure sensor 70 are not abnormal. That is, as shown in FIG. 4, in the case where the first gas density is equal to or higher than the lower limit value of the second gas density and equal to or lower than the upper limit value of the second gas density, the abnormality determination unit 86 determines that the first pressure sensor 54 and the second pressure sensor 70 are not abnormal. In this case, the abnormality determination unit 86 sets the abnormality flag 90 to 0. Thus, the series of processes end.

When the process proceeds from step S7 or step S8 to step S10, the abnormality determination unit 86 determines that the first pressure sensor 54 or the second pressure sensor 70 is abnormal. That is, as shown in FIG. 4, in the case where the first gas density is lower than the lower limit value of the second gas density or in the case where the first gas density is higher than the upper limit value of the second gas density, the abnormality determination unit 86 determines that the first pressure sensor 54 or the second pressure sensor 70 is abnormal. In this case, the abnormality determination unit 86 may notify the occupant of the abnormal state via a display device, an acoustic device, or the like. Further, in this case, the abnormality determination unit 86 sets the abnormality flag 90 to 1. Thus, the series of processes end.

As described above, in the case where the difference between the first gas density and the second gas density (the upper limit value and the lower limit value) is greater than a difference threshold (a threshold obtained in consideration of the error of the pressure sensor), the abnormality determination unit 86 determines that the first pressure sensor 54 or the second pressure sensor 70 is abnormal. The difference threshold is set based on the density of the hydrogen gas in the tank 24 when the hydrogen gas is supplied, and the error of the pressure sensor.

### 4. Other Embodiment

The abnormality determination unit 86 may perform the abnormality determination by comparing the state of charge (SOC), instead of performing the abnormality determination by comparing the gas density. In this case, the first gas density acquisition unit 82 and the second gas density acquisition unit 84 may calculate the SOC using the following Expression (2). The SOC indicates, as a percentage, the acquired density of the hydrogen gas with respect to a density pc of the hydrogen gas in the case where a predetermined pressure and a predetermined temperature of the hydrogen gas in the tank 24 are set as reference values. {(ρA·VA)+(ρB·VB)}/(VA+VB) in the following Expression (2) corresponds to the right side of the above Expression (1). It should be noted that 70 MPa that serves as a reference pressure when the tank 24 has been filled with the hydrogen gas may be set as the predetermined pressure. Any temperature may be set as the predetermined temperature.

$$soc = \frac{100}{ρ c} \times \frac{ρ A \cdot V A + ρ B \cdot VB}{V A + V B} \qquad ( 2 )$$

In this case, the abnormality determination unit 86 compares the SOC calculated by the first gas density acquisition unit 82 with an upper limit value of the SOC calculated by the second gas density acquisition unit 84. Further, the abnormality determination unit 86 compares the SOC calculated by the first gas density acquisition unit 82 with a lower limit value of the SOC calculated by the second gas density acquisition unit 84. Consequently, the abnormality determination unit 86 determines whether or not the first pressure sensor 54 or the second pressure sensor 70 is abnormal.

Incidentally, the abnormality determination device 72 may be provided in a system that uses gas other than the fuel cell system 10.

In the above-described embodiment, the upper limit value and the lower limit value of the second gas density are calculated, and the comparison between the first gas density and the upper limit value of the second gas density and the comparison between the first gas density and the lower limit value of the second gas density are performed. As another embodiment, an upper limit value and a lower limit value of the first gas density may be calculated, and the comparison between the second gas density and the upper limit value of the first gas density and the comparison between the second gas density and the lower limit value of the first gas density may be performed.

### 5. Advantageous Effects

In the above-described embodiment, the density of the hydrogen gas in the gas reservoir unit 16 is calculated, and whether or not the first pressure sensor 54 or the second pressure sensor 70 is abnormal is determined based on the calculated density. In contrast, it is also possible to calculate the moles of the hydrogen gas in the gas reservoir unit 16 and determine whether or not the first pressure sensor 54 or the second pressure sensor 70 is abnormal based on the calculated moles. However, the moles of hydrogen gas are expressed as “density of hydrogen gas×volume of tank 24/molecular weight of hydrogen gas”. Among these, the volume of the tank 24 includes an error. That is, the moles of the hydrogen gas include the error in the volume of the tank 24. In contrast, the density of the hydrogen gas does not include the error in the volume of the tank 24. Therefore, the abnormality determination of the above-described embodiment using the density of the hydrogen gas is more accurate than the abnormality determination using the moles of the hydrogen gas. That is, according to the above-described embodiment, it is possible to perform abnormality determination with high accuracy.

In the above-described embodiment, the density of hydrogen gas is not calculated by the state equation, but is acquired by using the map 88. The compressibility factor is taken into consideration in the map 88. According to the above-described embodiment, it is possible to acquire the density with higher accuracy than that calculated using the state equation. As a result, according to the above-described embodiment, it is possible to perform abnormality determination with high accuracy.

### 6. Supplementary Notes

The following supplementary notes are further disclosed in relation to the above-described embodiments.

### Supplementary Note 1

The abnormality determination device (72) according to the present disclosure includes: the first gas density acquisition unit (82) configured to acquire the first gas density, which is the density of a gas in the gas reservoir unit (16) when the gas reservoir unit has been filled with the gas via the gas filling path (40), based on the pressure of the gas detected by the first pressure sensor (54) provided in the gas filling path and the temperature of the gas detected by the temperature sensor (36A, 36B) provided in the gas reservoir unit; the second gas density acquisition unit (84) configured to acquire the second gas density, which is the density of the gas in the gas reservoir unit when the gas is supplied from the gas reservoir unit via the gas supply path (42), based on the pressure of the gas detected by the second pressure sensor (70) provided in the gas supply path and the temperature of the gas detected by the temperature sensor; and the abnormality determination unit (86) configured to determine whether or not the first pressure sensor or the second pressure sensor is abnormal, based on the first gas density acquired by the first gas density acquisition unit and the second gas density acquired by the second gas density acquisition unit.

The density of the gas does not include an error in the volume of the gas reservoir unit. Therefore, according to the above configuration, it is possible to perform abnormality determination with high accuracy.

### Supplementary Note 2

In the abnormality determination device according to Supplementary Note 1, the abnormality determination unit may determine that the first pressure sensor or the second pressure sensor is abnormal, in the case where a difference between the first gas density and the second gas density is greater than the difference threshold.

### Supplementary Note 3

In the abnormality determination device according to Supplementary Note 1 or 2, the second gas density may be the density of the gas in the gas reservoir unit when the gas is first supplied via the gas supply path after the gas reservoir unit has been filled with the gas via the gas filling path.

### Supplementary Note 4

In the abnormality determination device according to any one of Supplementary Notes 1 to 3, the gas reservoir unit may include a plurality of tanks (24), and the first gas density and the second gas density may each be the average density of the gas in the gas reservoir unit calculated based on the density of the gas filling each of the plurality of tanks and the capacity of each of the plurality of tanks.

### Supplementary Note 5

In the abnormality determination device according to Supplementary Note 4, a capacity ratio that is a ratio of the capacity of each of the tanks to a total capacity of the plurality of tanks may be calculated for each of the tanks, and the average density of the gas may be calculated based on the density of the gas in each of the tanks and the capacity ratio of each of the tanks.

### Supplementary Note 6

In the abnormality determination device according to any one of Supplementary Notes 1 to 5, the compressibility factor of the gas may be taken into consideration in the first gas density and the second gas density.

According to the above configuration, it is possible to acquire the density of the gas with higher accuracy than that calculated using the state equation. As a result, according to the above configuration, it is possible to perform abnormality determination with high accuracy.

### Supplementary Note 7

In the abnormality determination device according to Supplementary Note 6, the first gas density acquisition unit may acquire the first gas density based on the pressure of the gas detected by the first pressure sensor, the temperature of the gas detected by the temperature sensor, and the map (88) in which the pressure of the gas, the temperature of the gas, and the density of the gas in which the compressibility factor is taken into consideration are associated with each other, and the second gas density acquisition unit may acquire the second gas density based on the pressure of the gas detected by the second pressure sensor, the temperature of the gas detected by the temperature sensor, and the map.

### Supplementary Note 8

The abnormality determination method according to the present disclosure includes: the first gas density acquisition step (step S5) of acquiring the first gas density, which is the density of a gas in the gas reservoir unit when the gas reservoir unit has been filled with the gas via the gas filling path, based on the pressure of the gas detected by the first pressure sensor provided in the gas filling path and the temperature of the gas detected by the temperature sensor provided in the gas reservoir unit; the second gas density acquisition step (step S6) of acquiring the second gas density, which is the density of the gas in the gas reservoir unit when the gas is supplied from the gas reservoir unit via the gas supply path, based on the pressure of the gas detected by the second pressure sensor provided in the gas supply path and the temperature of the gas detected by the temperature sensor; and the abnormality determination step (step S7, step S8) of determining whether or not the first pressure sensor or the second pressure sensor is abnormal, based on the first gas density acquired in the first gas density acquisition step and the second gas density acquired in the second gas density acquisition step.

The density does not include an error in the volume of the gas reservoir unit. Therefore, according to the above configuration, it is possible to perform abnormality determination with high accuracy.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. An abnormality determination device comprising one or more processors that execute computer-executable instructions stored in a memory,
wherein the one or more processors execute the computer-executable instructions to cause the abnormality determination device to:
acquire a first gas density, which is a density of a gas in a gas reservoir unit when the gas reservoir unit has been filled with the gas via a gas filling path, based on a pressure of the gas detected by a first pressure sensor provided in the gas filling path and a temperature of the gas detected by a temperature sensor provided in the gas reservoir unit;
acquire a second gas density, which is a density of the gas in the gas reservoir unit when the gas is supplied from the gas reservoir unit via a gas supply path, based on a pressure of the gas detected by a second pressure sensor provided in the gas supply path and a temperature of the gas detected by the temperature sensor; and
determine whether or not the first pressure sensor or the second pressure sensor is abnormal, based on the first gas density that has been acquired and the second gas density that has been acquired.

2. The abnormality determination device according to claim 1, wherein
the one or more processors cause the abnormality determination device to determine that the first pressure sensor or the second pressure sensor is abnormal, in a case where a difference between the first gas density and the second gas density is greater than a difference threshold.

3. The abnormality determination device according to claim 1, wherein
the second gas density is a density of the gas in the gas reservoir unit when the gas is first supplied via the gas supply path after the gas reservoir unit has been filled with the gas via the gas filling path.

4. The abnormality determination device according to claim 1, wherein
the gas reservoir unit includes a plurality of tanks, and
the first gas density and the second gas density are each an average density of the gas in the gas reservoir unit calculated based on the density of the gas filling each of the plurality of tanks and a capacity of each of the plurality of tanks.

5. The abnormality determination device according to claim 4, wherein
a capacity ratio that is a ratio of the capacity of each of the tanks to a total capacity of the plurality of tanks is calculated for each of the tanks, and the average density of the gas is calculated based on the density of the gas in each of the tanks and the capacity ratio of each of the tanks.

6. The abnormality determination device according to claim 1, wherein
a compressibility factor of the gas is taken into consideration in the first gas density and the second gas density.

7. The abnormality determination device according to claim 6, wherein
the one or more processors cause the abnormality determination device to:
acquire the first gas density based on the pressure of the gas detected by the first pressure sensor, the temperature of the gas detected by the temperature sensor, and a map in which the pressure of the gas, the temperature of the gas, and the density of the gas in which the compressibility factor is taken into consideration are associated with each other; and
acquire the second gas density based on the pressure of the gas detected by the second pressure sensor, the temperature of the gas detected by the temperature sensor, and the map.

8. An abnormality determination method comprising:
acquiring a first gas density, which is a density of a gas in a gas reservoir unit when the gas reservoir unit has been filled with the gas via a gas filling path, based on a pressure of the gas detected by a first pressure sensor provided in the gas filling path and a temperature of the gas detected by a temperature sensor provided in the gas reservoir unit;
acquiring a second gas density, which is a density of the gas in the gas reservoir unit when the gas is supplied from the gas reservoir unit via a gas supply path, based on a pressure of the gas detected by a second pressure sensor provided in the gas supply path and a temperature of the gas detected by the temperature sensor; and
determining whether or not the first pressure sensor or the second pressure sensor is abnormal, based on the first gas density that has been acquired and the second gas density that has been acquired.
